(19) United States
(12) Patent Application Publication
(10) Pub. No.: US 2014/0267324 A1
(43) Pub. Date: Sep. 18, 2014

(54) COMPUTER FOR READING DATA FROM SERIAL PORT

(71) Applicant: HON HAI PRECISION INDUSTRY CO., LTD., New Taipei (TW)

(72) Inventor: CHIH-HUANG WU, New Taipei (TW)

(73) Assignee: HON HAI PRECISION INDUSTRY CO., LTD., New Taipei (TW)

(21) Appl. No.: 13/971,819

(22) Filed: Aug. 20, 2013

(30) Foreign Application Priority Data
Mar. 12, 2013 (TW) 102108739

(51) Int. Cl. G06T 1/20

(52) U.S. Cl. CPC G06T 1/20
USPC 345/520

(57) ABSTRACT

A computer system includes an input port connected with a serial port, a standby power, a driving system, a first output port, and a first display. The driving system includes a detecting module connected to the input port and the first output port. The detecting module detects whether the serial port inputs data to the input port and the first output port is connected to the first display. A converting module connected to the detecting module and the input port, reads the data from the serial port via the input port and converts the data into a displayable format of the first display. An output module connected to the converting module and the first output port, outputs the data in the first display format to the first display via the first output port.

### BACKGROUND

1. Technical Field

The present disclosure relates to computers, and particularly to a computer for reading data from a serial port without starting up the computer.

2. Description of Related Art

At present, to read data from a serial port, a computer must be started up and required applications to be run on the computer, which is not convenient.

Therefore, it is desirable to provide a computer for reading data from a serial port without starting up the computer.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 shows a computer system for reading data from a serial port according to a first embodiment.

FIG. 2 shows a computer system for reading data from a serial port according to a second embodiment.

### DETAILED DESCRIPTION

Embodiments of the present disclosure will be described with reference to the drawings.

FIG. 1 shows a computer system 100 for reading data from a serial port 200, according to an embodiment. The computer system 100 includes an input port 10, a driving system 20, a power supply 30, a first output port 401, and a first display 501. The input port 10 is configured to connect with the serial port 200.

The power supply 30 includes a standby power unit 301. The standby power unit 301 is configured to supply a standby power even before the computer system 100 is started up. The standby power is 3.3V.

The driving system 20 is connected to the standby power unit 301 and is activated when receiving the standby power. The driving system 20 is a software which includes a detecting module 201, a converting module 202, and an output module 203. The detecting module 201 is connected to the input port 10 and the first output port 401, and is configured to detect if the serial port 200 inputs data to the input port 10 and the first output port 401 is connected to the first display 501. The converting module 202 is connected to the detecting module 201 and the input port 10, and is configured to read the data from the serial port 200 through input port 10 and convert the data into a displayable format of the first display 501. The output module 203 is connected to the converting module 202 and the first output port 401, and is configured to output the data in the first display format to the first display 501 via the first output port 401.

As such, the computer system 100 can read and display the data from the serial port 200 even before the computer system 100 is started up.

The driving system 20 further includes a setting module 204. The computer system 100 further includes an input unit 60. The setting module 204 is connected to the input unit 60, the detecting module 201, the converting module 202, and the output module 203. The input unit 60, such as a keypad, is configured to receive user input. The setting module 204 is configured to receive the user input and thus set various parameters of the detecting module 201, the converting module 202, and the output module 203, such as baud rate, serial port, and output resolution.

The detecting module 201, the converting module 202, the output module 203, and the setting module 204 can be integrated into a microcontroller or be individual circuited elements.

The computer system 100 further includes a central processing unit (CPU) 70, a graphics processing unit (GPU) 80, a second output port 402, and a second display 502. The power supply 30 further includes a main power unit 302. The main power unit 302 is connected to the CPU 70 and the GPU 80, and is configured to provide a main power after the computer system 100 has started up. The CPU 70 is connected to the main power unit 302 and is configured to process and output information to the GPU 80 when receiving the main power. The GPU 80 is connected to the second display 502 through the second output port 402 and is configured to convert the information into a displayable format of the second display 502 and outputting the information in the displayable format to the second display 502 through the second output port 402.

As such, the first display 501 can display the data from the serial port 200 while the second display 502 display information from the CPU 70, even when the computer system 100 has started up.

The input port 10, the first output port 401, and the second output port 402 can be a video graphics adapter, and can be further integrated with the driving system 20 and the GPU 80 into a graphics card.

FIG. 2 shows another computer system 300 for reading data from the serial port 200, according to an embodiment. The computer system 300 is essentially to the same as the computer system 100. However, the second output port 402 and the second display 502 are omitted and a switch 90 is added.

The switch 90 such as a multiplexer is connected to the first output port 401, the output module 203, the GPU 80, and the setting module 204. The setting module 204 is also configured to output a switch signal when the output module 203 outputs the data. The switch 90 is configured to connect the first output port 401 with the GPU 304 when the GPU 80 outputs the information, and switch the connection of the first output port 401 from the GPU 80 to the output module 203 when receiving the switch signal. As such, the first display 501 can display the data before and after the computer system 100 is started up.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. A computer system comprising:
an input port connected with a serial port;
a standby power supplying a standby power even before the computer system is started up;
a driving system connected to the standby power and to be activated when receiving the standby power;
a first output port; and
a first display;
wherein the driving system comprises:
a detecting module connected to the input port and the first output port, to detect whether the serial port inputs data to the input port and the first output port is connected to the first display;
a converting module connected to the detecting module and the input port, to read the data from the serial port via the input port and convert the data into a displayable format of the first display; and
an output module connected to the converting module and the first output port, to output the data in the first display format to the first display via the first output port.

2. The computer system of claim 1, further comprising an input unit, wherein the driving system further comprises a setting module, the setting module is connected to the input unit, the detecting module, the converting module, and the output module, the input unit is configured to receive user inputs, the setting module is configured to receive the user inputs and thus set various parameters of the detecting module, the converting module, and the output module.

3. The computer system of claim 2, wherein the detecting module, the converting module, the output module, and the setting module are integrated into a microcontroller or individual circuited elements.

4. The computer system of claim 2, further comprising a central processing unit (CPU), a graphics processing unit (GPU), a second output port, and a second display, wherein the power supply further comprises a main power unit, the main power unit is connected to the CPU and GPU, and is configured to provide a main power after the computer system has started up, the CPU is connected to the main power unit and is configured to processing information and outputting information to the GPU when receiving the main power, the GPU is connected to the second display through the second output port and is configured to convert the information into a displayable format of the second display and outputting the information in the displayable format to the second display through the second output port, as such, the first display displays the data from the serial port while the second display displays information from the CPU, even then the computer system has started up.

5. The computer system of claim 4, wherein the input port, the first output port, and the second output port are video graphics adapters, and integrated further with the driving system and the GPU into a graphics card.

6. The computer system of claim 2, further comprising a central processing unit (CPU), a graphics processing unit (GPU), a switch, wherein the switch is connected to the first output port, the output module, the GPU, and the setting module, the setting module is also configured to output a switch signal when the output module outputting the data, the switch is configured to connect the first output port with the GPU when the GPU outputting the information and switch the connection of the first output port from the GPU to the output module when receiving the switch signal, as such, the first display displays the data before and after the computer system is started up.

7. The computer system of claim 6, wherein the input port, the first output port are video graphics adapters, and integrated further with the driving system and the GPU into a graphics card.

8. The computer system of claim 1, wherein the standby power is 3.3V.
